(19) United States
(12) Patent Application Publication
(10) Pub. No.: US 2012/0059846 A1
(43) Pub. Date: Mar. 8, 2012

(54) METHOD FOR RETRIEVING OBJECT INFORMATION AND PORTABLE ELECTRONIC DEVICE APPLYING THE SAME

(76) Inventors: Ling-Fei SUNG, Taipei (TW); Yung-Hsin CHANG, Taipei (TW); Jui-Fang CHI, Taipei (TW); Yu-Wei HSIANG, Taipei (TW); Yi-Chun CHUNG, Taipei (TW); Ching-Hsiang CHIANG, Taipei (TW)

(21) Appl. No.: 13/224,844

(22) Filed: Sep. 2, 2011

(30) Foreign Application Priority Data
Sep. 6, 2010 (TW) 099130099

(51) Int. Cl. G06F 17/30

(52) U.S. Cl. 707/769; 707/E17.014

(57) ABSTRACT

A method for retrieving object information is applied to a portable electronic device and includes the following steps. A global position system (GPS) module receives a position signal to get GPS data. A magnetic sensing module senses magnetic field to get azimuth direction data. A touch input module inputs an event which is a movement moving from a touch position towards an object to get input direction data. A processing module gets angle difference data according to the azimuth direction information and the input direction information. The information of the corresponding object from a database according to the parameters of the GPS data is retrieved, and the parameters of the GPS data, the azimuth direction data and the angle difference data are used by the processing module.

### CROSS REFERENCE TO RELATED APPLICATIONS

This Non-provisional application claims priority under 35 U.S.C. §119(a) on Patent Application No(s). 099130099 filed in Taiwan, Republic of China on Sep. 6, 2010, the entire contents of which are hereby incorporated by reference.

### BACKGROUND OF THE INVENTION

1. Field of Invention

The invention relates to a method for retrieving object information and, more particularly, to a method for retrieving object information applied to a portable electronic device.

2. Related Art

Online map is an interesting and practical network application in recent years. Statistically, network flow of the online map is almost doubled since 2010 and continues increasing. More and more users use the function to search interested landmarks or roads, plan travel routines, or even use cooperating with a global position system (GPS) or other portable devices with a positioning function.

However, when the user wants to search for the information about a building or a scenery spot nearby at any place, users have to connect the browser of the devices to the Online map website, enable the positioning function of online map to locate the position of the user, click to search and find a data list of nearby spots, and then select the matching links from the list to get the information of the building or the scenery spot. It takes much time to load a website and select the information from a list, and it also needs to stop the application in linking the browser, which cannot reach the goal of convenient, quick and real-time in searching.

### SUMMARY OF THE INVENTION

A method for retrieving object information is provided. It is applied to a portable electronic device and does not need to execute specific map software. The method enables the user to operate simply and intuitively, that is, the user can quickly get the object information without stopping application programs in using or task in operating.

The method for retrieving object information is applied to a portable electronic device which includes a GPS module, a magnetic sensing module, a touch input module and a processing module. The method for retrieving object information includes the following steps. The GPS module receives a position signal to get GPS data. The magnetic sensing module senses magnetic field to get azimuth direction data. The touch input module inputs an event which is a movement moving from a touch position toward an object to get input direction data. The processing module gets angle difference data according to the azimuth direction information and the input direction information. The information of the corresponding object from a database according to the parameters of the GPS data is retrieved, and the parameters of the GPS data, the azimuth direction data and the angle difference data are used by the processing module.

The method for retrieving object information and the portable electronic device utilizes simple gestures as an input method. Gesture movement is a very important guiding index since that the movement of the gestures on the touch input module is in accordance with the position of the user and the object. After the movement is combined with the GPS data and the azimuth direction data, the corresponding data about the user and the object can be calculated and retrieved from the database. The method for retrieving object information disclosed herein is simple and intuitive for retrieving the object information.

Compared with the conventional technology, the method for retrieving object information and the portable electronic device applying the same can quickly retrieve the object information from the database in a visual mode of the object azimuth and some simple inputting gestures. It does not need to stop application programs in using or task in operating, and it also does not need to enable a specific map program or press multiple buttons. It simplifies complicated operating process, and saves time. Moreover, the method for retrieving object information does not need to preinstall a large quantity of the object images in the device for the user to select, which saves the space and reduces the cost.

These and other features, aspects and advantages of the disclosure will become better understood with regard to the following description, appended claims, and accompanying drawings.

### BRIEF DESCRIPTION OF THE DRAWINGS

FIG. 1 is a schematic diagram showing a portable electronic device applying a method for retrieving object information in a first embodiment;

FIG. 2 is a block diagram showing the portable electronic device in FIG. 1;

FIG. 3 is a flowchart showing a method for retrieving object information in a first embodiment;

FIG. 4A and FIG. 4B are schematic diagrams showing that a user operates a portable electronic device in FIG. 1 to execute a method for retrieving object information in different ways in a first embodiment;

FIG. 5 is a schematic diagram showing that a portable electronic device displays information retrieved via a method for retrieving object information in a first embodiment;

FIG. 6A and FIG. 6B are schematic diagrams showing the process of inputting an event via a method for retrieving object information in different ways in a second embodiment; and

FIG. 7A and FIG. 7B are schematic diagrams showing the process of inputting an event via a method for retrieving object information in different ways in a third embodiment.

### DETAILED DESCRIPTION OF THE INVENTION

A method for retrieving object information in embodiments is illustrated referring to the relating figures, and the same symbols denote the same components.

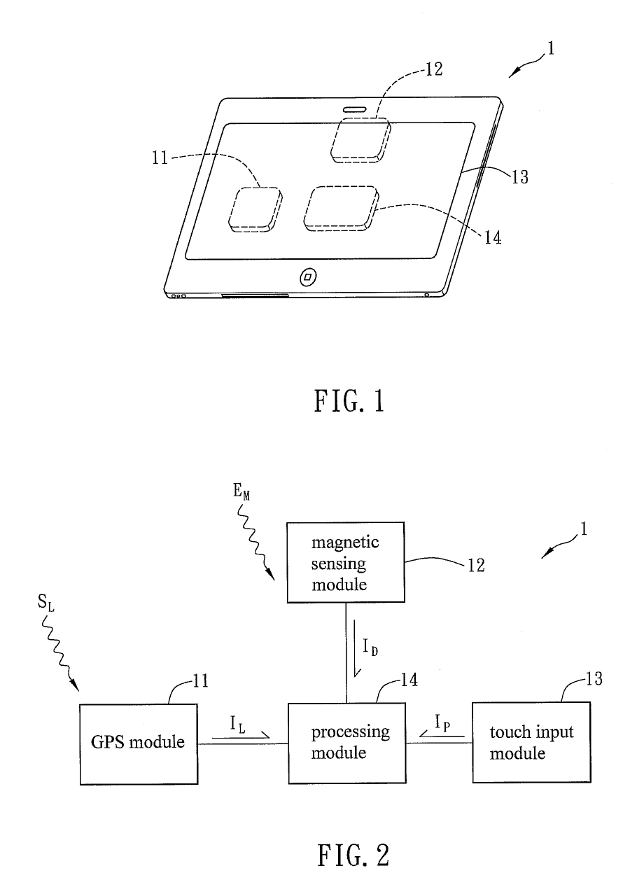

FIG. 1 is a schematic diagram showing a portable electronic device applying a method for retrieving object information in a first embodiment. FIG. 2 is a block diagram showing a portable electronic device in FIG. 1. In the embodiment, as shown in FIG. 1 and FIG. 2, a portable electronic device 1 includes a GPS module 11, a magnetic sensing module 12, a touch input module 13 and a processing module 14.

The portable electronic device 1 may be a smart phone, a tablet computer, a portable navigation device or a personal digital assistance (PDA), which is not limited herein. The magnetic sensing module 12 may be an electronic compass or other devices which can sense the magnetic field. The touch input module 13 may be one or a combination of a touch screen and a touch pad.

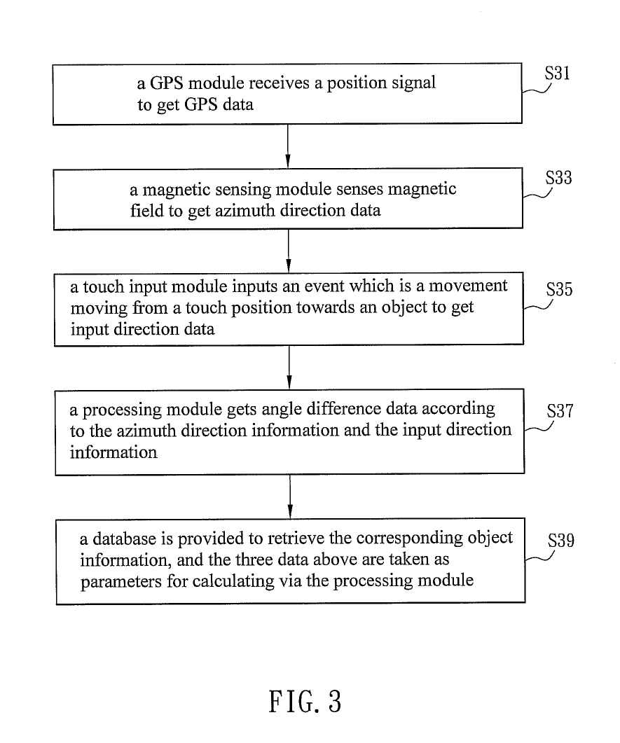

FIG. 3 is a flowchart showing steps of a method for retrieving object information in a first embodiment. In the embodiment, the method for retrieving object information includes the following steps. The GPS module receives a position signal to get GPS data (Step S31). The magnetic sensing module senses magnetic field to get azimuth direction data (Step S33). The touch input module inputs an event to get input direction data (Step S35). The processing module calculates the angle difference between the azimuth direction and the input direction according to the azimuth direction data and the input direction data to get angle difference data (Step S37). The GPS data, the azimuth direction data, and the angle difference data are taken as parameters for the processing module to calculate and get the corresponding object information from a provided database (Step S39).

The steps of the method for retrieving object information in the first embodiment are illustrated in detail accompanying the electronic device in FIG. 1 and FIG. 2.

As shown in FIG. 2 and FIG. 3, in Step S31, the user receives position signals S_{L} which may be sent by three navigation satellites, respectively, via the GPS module 11 in the portable electronic device 1, calculates the position signals S_{L} to get the GPS data I_{L}, and sends the GPS data I_{L} to the processing module 14 to be used as a parameter for the following steps.

Step 31 may be performed via an application program in a storage module (not shown), the processing module 14 drives the GPS module 11 to receive the position signal S_{L} continuously at a constant interval, and calculate the position signal to get the GPS data I_{L}. The user also may input a specific signal, such as pressing a virtual GPS start button on the touch input module 13, to utilize the portable electronic device 1 to perform Step S31.

In Step S33 of the embodiment, the magnetic sensing module 12 of the portable electronic device 1 defines the south and the north poles such as by sensing the earth magnetic field to allow the user to get the azimuth direction data I_{D}, and then the azimuth direction data I_{D} are sent to the processing module 14 to be used as a parameter for the following steps.

In the embodiment, the magnetic sensing module 12 is an electronic compass which may be manufactured via a giant magneto resistive (GMR) sensor or according to the fluxgate theory, and it also may be a two-dimension (2D) or three-dimension (3D) electronic compass, which is not limited herein. The azimuth direction data I_{D} includes the direction data of the facing direction of the user when operating the portable electronic device 1. The mode and timing of Step S32 are similar to those in Step S31, which may be a continuous mode or a manual mode.

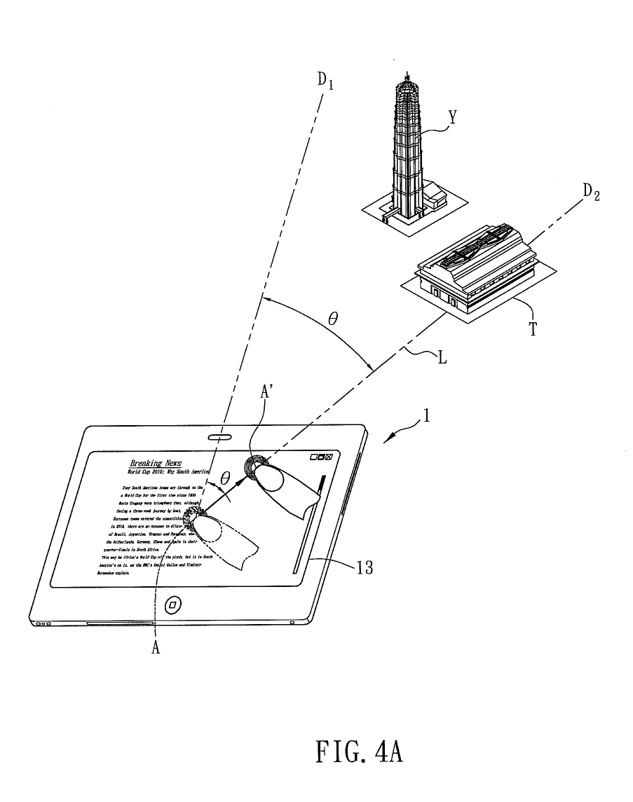

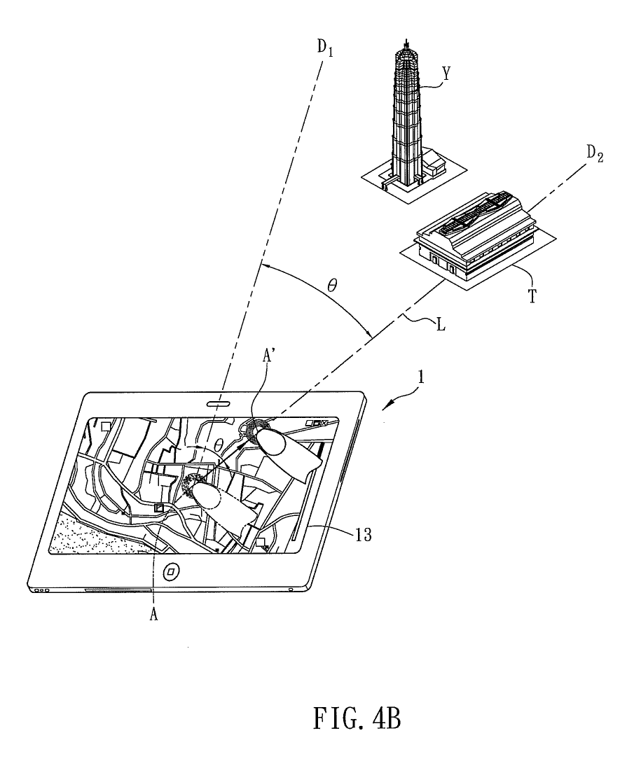

FIG. 4A is a schematic diagrams showing that a user operates the portable electronic device in FIG. 1 to execute the method for retrieving object information. As shown in FIG. 2 to FIG. 4, in Step S35 of the embodiment, the user may input an event via the touch input module 13 based on the relative position between the object and the user.

Retrieving object information in the embodiment does not need to enable or browse any map programs in the portable electronic device 1 according to the method disclosed herein, only gestures are needed. The event can be inputted without interruption even if other application programs such as an E-book program shown in FIG. 4A are under operating. Furthermore, the portable electronic device 1 may also execute the method for retrieving object information in the embodiment while a map program is enabled as shown FIG. 4B.

In FIG. 4A, in the embodiment, an angle difference θ is between the facing direction D1 of the user and the object T. The user holds the portable electronic device 1, and he or she puts the portable electronic device 1 at a position such as in front of the face or chest to look directly and operate easily. Consequently, when the user touches the touch position A at the touch input module 13, an angle the same as or similar to the angle difference θ is formed between the direction D1 and a connection line L connecting the touch position A and the object T.

As a result, the user may move the finger along the connection line L, which is taken as a gesture for inputting the event, the moving trace or path forms a specific direction D2 relative to the direction D1, and an angle difference θ is between the direction D1 and the direction D2. The event and the specific direction D2 are calculated by the processing module 14 to get the input direction data I_{P} as a parameter for the following steps.

In FIG. 4, the event is a movement from the touch position A towards the object T along the connection L. In the embodiment, the movement for inputting the event is executed by touching the touch position A at the touch input module 13 and then moving to another touch position A′.

The event may also be inputted via different gestures. For example, after touching the touch position A, then touching another touch position A′ at the connection line L, the event is inputted. That is, the user need not contact the touch input module 13 continuously, and the connection line between the two points A and A′ is calculated to be used as a relating data of the input direction data I_{P}. Furthermore, the distance between the touch position A and another touch position A′ is not related to the information of the object T. However, in other embodiments, the distance between the two points A and A′ also may be taken as a reference parameter to find the object T more precisely via a program.

Since the azimuth direction data I_{D} and the input direction data I_{P} can be obtained in Step S33 and Step S35, in Step S37, the angle difference θ between the two directions are calculated. When the azimuth direction data I_{D} and the input direction data Iₚ are inputted to the processing module 14, the angle difference data is taken as a reference parameter of the position of the object T.

In the embodiment, the azimuth direction D1 is the direction that the user faces, and the input direction D2 is the direction that the user moves the finger from the touch position A towards the object T along the connection line therebetween. The angle difference θ between the azimuth direction and the input direction is the same with the angle difference between the object T and the direction which the user faces.

Please refer to FIG. 3 and FIG. 4, in Step S39 of the embodiment, the database may be a built-in database in the portable electronic device 1 or a database connected to the internet, which is not limited herein. Since the three data (the GPS data I_{L}, the azimuth direction data I_{D} and the angle difference data) got in Step S31 to Step S37 represent the position, the facing direction and the angle, respectively, the three data are taken as parameters and inputted to the processing module 14 to get integrated data after the calculation. The integrated data is used for searching and comparing in the database to retrieve the object information matching the integrated data.

In detail, the GPS data I_{L} indicates the position of the portable electronic device 1 (that is the position of the user). The GPS data I_{L} is used as a parameter for the processing module 14 to limit the searching scope in the database to the nearby area. The azimuth direction data I_{D} indicates the azimuth including the left azimuth, the right azimuth, the front azimuth and the back azimuth of the user. The azimuth also includes the azimuth direction D1 which the user faces when operating the portable electronic device 1. The azimuth is used as a basic reference for determining the azimuth direction of the object T.

The angle difference data indicates the angle difference θ between the input direction and the azimuth direction D1 which the user faces. According to the angle difference data and the azimuth direction data Id, the azimuth direction of the object T relative to the front side of the user is calculated to indicate the processing module 14 to search from the database and retrieve the proper information of the object T.

In the embodiment, Step S31 to Step S37 are performed to get the GPS data I_{L}, the azimuth direction data I_{D} and the angle difference data in sequence, but the order is not limited herein. In another embodiment, the azimuth direction data I_{D} may be got first, and then the angle difference data is calculated. Finally, the GPS data I_{L} is added to retrieve the information of the object T from the database.

The method for retrieving object information in the embodiment is applied to the portable electronic device for the user to get the information of the interested object. The gestures are used as an input method, and thus, the user can execute the method via gestures after determining the angle relation relative to the object in a visual mode. It does not need to be out of the application program in executing or stop the task in operating, which saves time in enabling the map software, and improves the information retrieving efficiency.

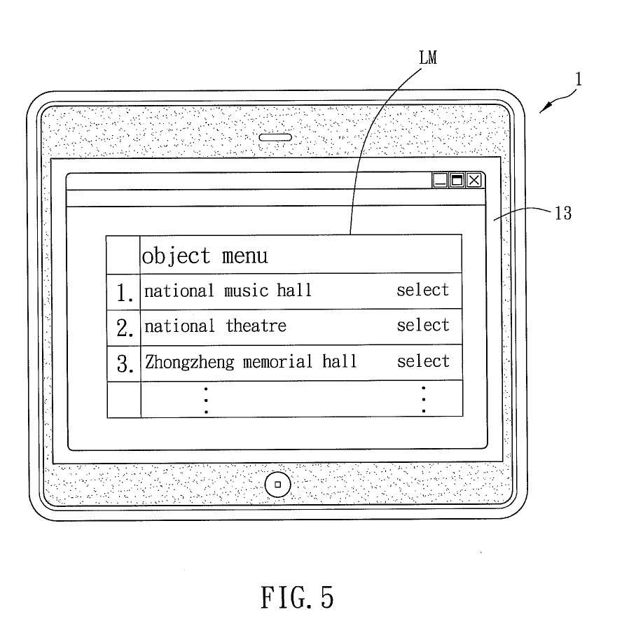

FIG. 5 is a schematic diagram showing that a portable electronic device displays information retrieved via a method for retrieving object information in a first embodiment. As shown in FIG. 5, the touch input module 13 is a touch screen and includes a display module (not shown). Consequently, after the processing module 14 retrieves the object information, a display signal may be outputted to make the information display on the display module, and further to allow the user to browse.

Furthermore, since the candidate object information in the database meeting the three data may be more than one group, the display module may display a menu including the object (the object T shown in FIG. 4) information and information of other objects at the same azimuth direction for the user to browse or select.

Since the method for retrieving object information is based on the touch control technology, specific gestures are used as the input method. More gestures for the method for retrieving object information cooperating with the portable electronic device and the effects are further illustrated hereinafter.

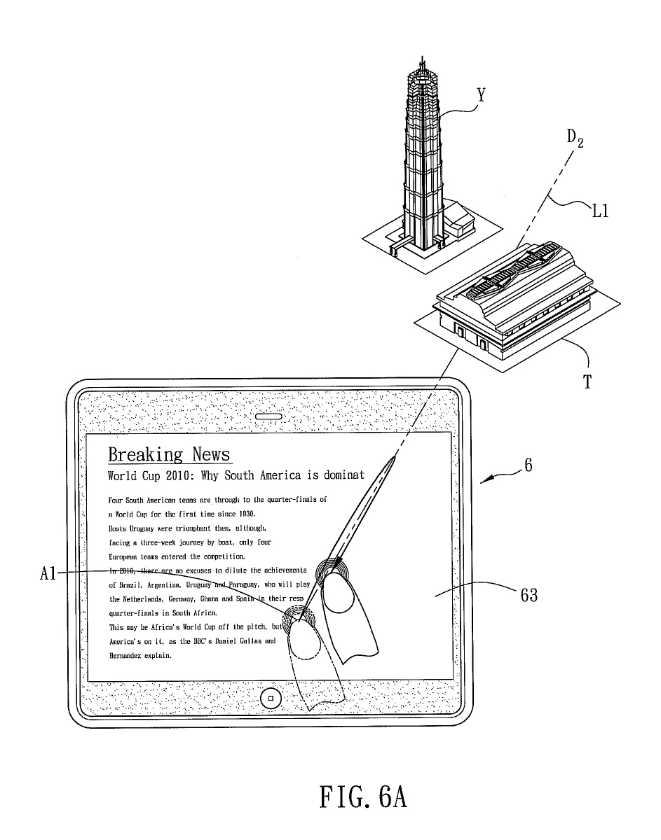

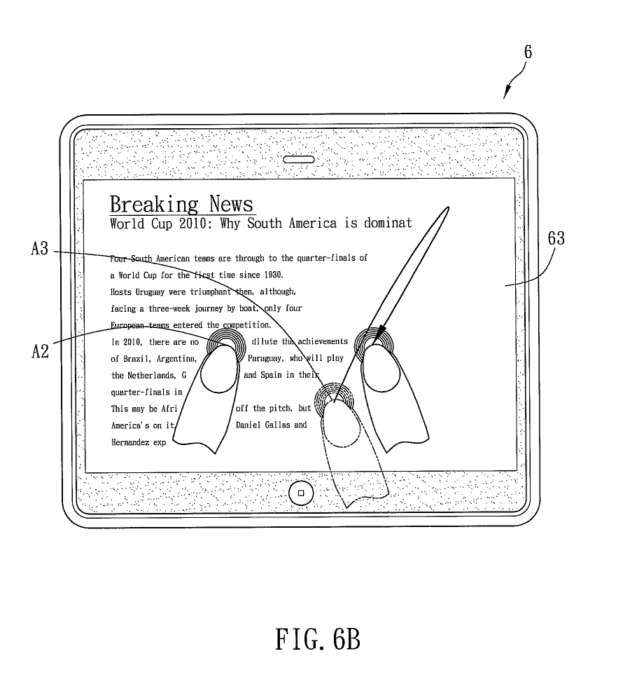

FIG. 6A and FIG. 6B are schematic diagrams showing the process of inputting an event via a method for retrieving object information in different ways in a second embodiment. In FIG. 6A, the steps in the embodiment are approximately the same with those in the first embodiment. The difference is that when a call event is inputted, the portable electronic device 6 is at a standby state to receive the next event.

The call event may be a long-term press on the touch position A1 of the touch input module 63. To input the event, the user moves the finger from the touch position A1 towards the object T along the connection line L1, and then moves a distance away from the object T backwardly. The touch position A1 is not a specific position at the touch input module 63, but the initial touch position at the touch input module 63.

In FIG. 6B, the method of inputting the event is the same with that in FIG. 6A. However, when inputting the call event, the touch position A2 and another touch position A3 are keeping touched, then the event is executed to be inputted at the touch position A3. The touch position A2 and the touch position A3 are not been touched until the event is totally received.

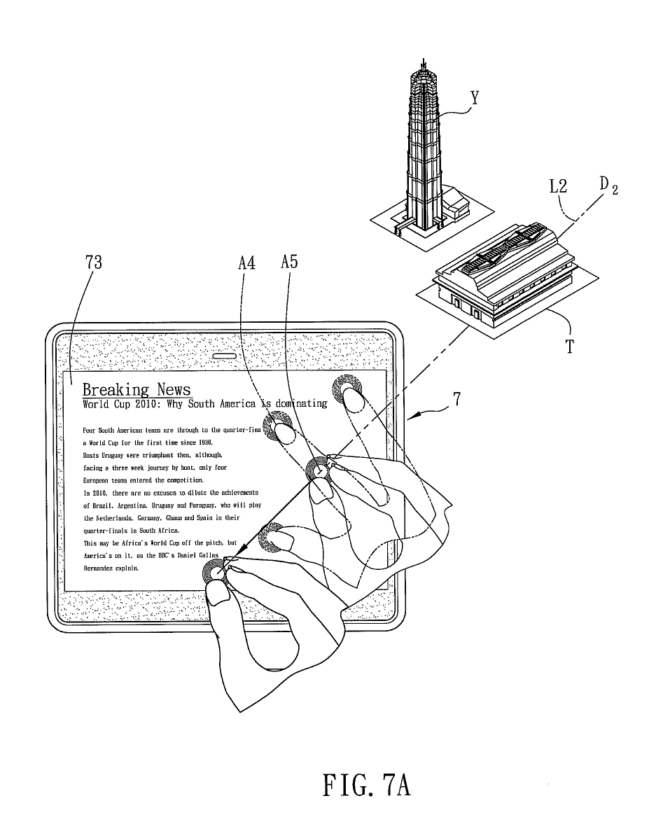

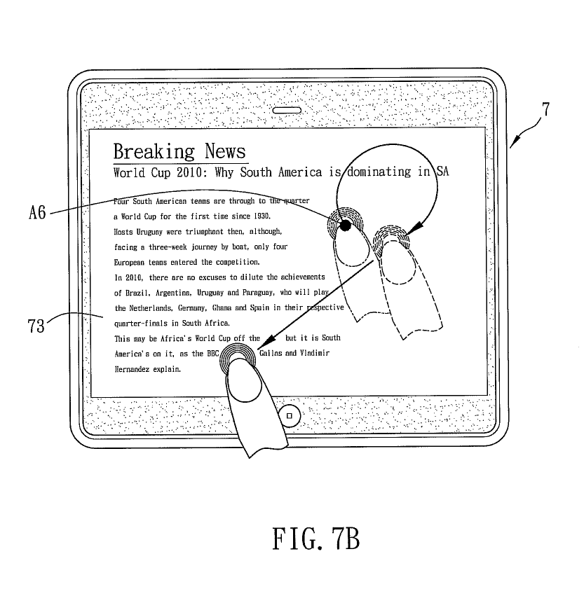

FIG. 7A and FIG. 7B are schematic diagrams showing the process of inputting an event via a method for retrieving object information in different ways in a third embodiment. In FIG. 7A, to input the call event, several touch points (such as the three touch points A4) are touched at the touch input module 73 at the same time. Then, the user moves his finger towards the center of the touch points A4, which is taken as the call event. After the call event is inputted to make the portable electronic device 1 ready to receive the event, the user backwards moves his finger away from the object T for a distance along the connection L2 between the touch position A5 and the object T, and the event is inputted.

In FIG. 7B, to input the call event, the user first touches a touch position A6 at the touch input module 73, and then the user moves his finger along a circular path while keeping contacting the touch input module 73 to input the call event. The way for inputting the event to obtain the azimuth information are the same with that in FIG. 7A, which is illustrated in detail above and omitted herein.

A portable electronic device applying the method for retrieving object information is further disclosed. The portable electronic device includes a processing module, a GPS module, a magnetic sensing module and a touch input module. The GPS module is connected to the processing module and receives a position signal to get GPS data.

The magnetic sensing module is connected to the processing module and senses the magnetic field to get the azimuth direction data. The touch input module is connected to the processing module and receives an event. The event is a movement moving from a touch position on the touch input module towards an object to get input direction data. The processing module calculates an angle difference between the azimuth direction and the input direction to get angle difference data according to the azimuth direction data and the input direction data. Then, the GPS data, the azimuth direction data and the angle difference data are taken as parameters to calculate to retrieve information of the corresponding object from a database.

The portable electronic device is the same with the portable electronic device 1 (referring to FIG. 1 and FIG. 2) in the first embodiment, and its components, structure and the way of applying the method for retrieving object information are the same with those of the portable electronic device 1, which is omitted herein.

In sum, simple gestures are used as an input method of the method for retrieving object information and the portable electronic device applying the same. Since the movement of the gestures on the touch input module is in accordance with the position of the user and the object, it is an important guidance. After the movement is combined with the GPS data and the azimuth direction data, the corresponding data about the user and the object can be calculated and retrieved from the database. The method for retrieving object information is simple and intuitive.

Compared with the conventional technology, the method for retrieving object information and the portable electronic device applying the same in the embodiments can quickly retrieve the object information from the database by determining the object azimuth in a visual mode and some simple input gestures. It does not need to switch application programs in executing or stop the task in operating, and it also does need to enable a specific map program or press multiple buttons. Consequently, it simplifies operating process and saves time. Moreover, according to the embodiments, it also does not need to preinstall a large quantity of the object images in the device for the user to select, which saves spaces and reduces the cost.

Although the present disclosure has been described in considerable detail with reference to certain preferred embodiments thereof, the disclosure is not for limiting the scope of the disclosure. Persons having ordinary skill in the art may make various modifications and changes without departing from the scope. Therefore, the scope of the appended claims should not be limited to the description of the preferred embodiments described above.

What is claimed is:

1. A method for retrieving object information applied to a portable electronic device including a global position system (GPS) module, a magnetic sensing module, a touch input module, and a processing module, the method comprising the following steps:
receiving a position signal by the GPS module to get GPS data;
sensing a magnetic field by the magnetic sensing module to get azimuth direction data;
inputting an event by the touch input module to get input direction data, wherein the event is a movement moving from a touch position on the touch input module towards an object;
calculating an angle difference between an azimuth direction and an input direction by the processing module to get angle difference data according to the azimuth direction data and the input direction data; and
retrieving information of the corresponding object from a database according to the parameters of the GPS data, the azimuth direction data and the angle difference data to calculate via the processing module.

2. The method for retrieving object information according to claim 1, wherein the magnetic sensing module is an electronic compass.

3. The method for retrieving object information according to claim 1, wherein the touch input module is a touch screen, a touch pad or the combination thereof.

4. The method for retrieving object information according to claim 1, wherein the azimuth direction is a facing azimuth direction in operating the portable electronic device.

5. The method for retrieving object information according to claim 1, wherein a standby state of the portable electronic device is enabled to make the portable electronic device ready to receive the event by a long-term press at the touch input module before the event is inputted, multi-points touching the touch input module and moving towards a center of touch points, contacting the touch input module continuously and moving along a circular path, or contacting another position different from the touch position continuously until the event is inputted.

6. The method for retrieving object information according to claim 1, wherein the event is a movement moving from the touch position towards the object and then moving backwards for a certain distance, or a movement moving away from the object for a distance along a connection line between the object and the touch position.

7. The method for retrieving object information according to claim 1, further comprising the following step:
displaying the information of the object on a display module of the portable electronic device via the processing module.

8. The method for retrieving object information according to claim 7, wherein the display module displays a menu including the information of the object.

9. The method for retrieving object information according to claim 1, wherein the database is a built-in database of the portable electronic device, a database connected to the internet or the combination thereof.

10. The method for retrieving object information according to claim 1, wherein the portable electronic device is a smart phone, a tablet computer, a portable navigation device or a personal digital assistance (PDA).

11. A portable electronic device, comprising:
a processing module;
a GPS module connected to the processing module and receiving a position signal to get GPS data;
a magnetic sensing module connected to the processing module and sensing a magnetic field to get azimuth direction data; and
a touch input module connected to the processing module and receiving an event;
wherein the event is a movement moving from a touch position on the touch input module towards an object along a connection line between the touch position and the object to get input direction data, the processing module calculates an angle difference between the azimuth direction and the input direction to get angle difference data according to the azimuth direction data and the input direction data, and the GPS data, the azimuth direction data and the angle difference data are taken as parameters to calculate to retrieve information of the corresponding object from a database.

12. The object information retrieving device according to claim 11, wherein the magnetic sensing module is an electronic compass.

13. The object information retrieving device according to claim 11, wherein the touch input module is a touch screen, a touch pad or other combinations or the combination thereof.

14. The object information retrieving device according to claim 11, wherein the azimuth direction is a facing azimuth direction in operating the portable electronic device.

15. The object information retrieving device according to claim 11, wherein the touch input module receives a call event to call a standby state of the portable electronic device to be at a standby state for receiving the event, and the call event is an long-term press on the touch input module before inputting the event, a multi-touch on the touch input module and moving towards a center of touch points, contacting the touch input module continuously and moving along a circular path, or contacting another position different from the touch position continuously until the event input is finished.

16. The object information retrieving device according to claim 11, wherein the event is a movement moving from the touch position towards the object and then moving backwards for a certain distance, or a movement away from the object for a distance along a connection line between the object and the touch position.

17. The object information retrieving device according to claim 11, further comprising:
a display module connected to the processing module, receiving and displaying the information of the object retrieved by the processing module.

18. The object information retrieving device according to claim 17, wherein the display module displays a menu including the information of the object.

19. The object information retrieving device according to claim 11, wherein the database is a built-in database of the portable electronic device, a database connected to the internet or the combination thereof.

20. The object information retrieving device according to claim 11, wherein the portable electronic device is a smart phone, a tablet computer, a portable navigation device or a PDA.
